(19) United States
(12) Patent Application Publication
(10) Pub. No.: US 2006/0050015 A1
(43) Pub. Date: Mar. 9, 2006

(54) Display and color cathode ray tube

(76) Inventors: Tsuneo Kusunoki, Tokyo (JP); Katsutoshi Ohno, Tokyo (JP); Koji Fujita, Kanagawa (JP); Takahiro Igarashi, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/535,388

(22) PCT Filed: Nov. 20, 2003
(86) PCT No.: PCT/JP03/14846

§ 371 Date: May 17, 2005

(30) Foreign Application Priority Data
Nov. 20, 2002 (JP) 2002-336917

(51) Int. Cl. G09G 3/00

(52) U.S. Cl. 345/30

(57) ABSTRACT

The present invention aims at compatibility between the improvement in luminance or suppression of deterioration in luminance and the improvement in contrast with respect to a display apparatus and a color cathode-ray tube. Each of the display apparatus and the color cathode-ray tube according to the present invention includes: a fluorescent screen having a color-filter layer and a phosphor layer, which is formed inside a panel glass having light transmissivity of 55% to 20% when a wavelength is 546 nm and a plate thickness is 20 mm and in which at least the phosphor layer is formed by the transfer method.

### TECHNICAL FIELD

The present invention relates to a display apparatus and a color cathode-ray tube including a fluorescent screen in which a phosphor layer is combined with a color filter.

### BACKGROUND ART

It has heretofore been intended to improve contrast of a picture in a display apparatus including, for example, a color cathode-ray tube. To improve the contrast, there are methods, one of which is to increase luminance and the other of which is to reduce reflectance of external light on a tube surface. Thus, there has been proposed a method for improving the contrast by lowering the external-light reflectance using a panel glass with low transmissivity which forms the fluorescent screen. Alternatively, there has been proposed another method for improving the contrast using what is called a “phosphor with pigment” as the phosphor forming the fluorescent screen, in which pigment having the same color as a luminous color of the phosphor is stuck on the surface of phosphor particles. However, the use of the panel glass with low transmissivity will lower the luminance of a display apparatus. Moreover, the use of the phosphor with pigment makes the pigment absorb the luminous light from the phosphor with the result that the luminance decreases, and also makes the pigment exfoliate during a manufacturing process of display apparatus, which have been considered as problems.

Thus, the applicant of the present invention has proposed a structure in which a color-filter layer having the same color as that of the phosphor layer intervenes between the phosphor layer and the panel glass (refer to Patent Literature 1 and 2). The fluorescent screen with the color-filter layer attains compatibility between reduction in the external-light reflectance and reduction in the luminance deterioration, because the color-filter layer absorbs the external light and the luminous light from the phosphor layer transmits the color-filter layer. However, in order to manufacture a color cathode-ray tube having the color-filter layer by the conventional slurry method, a number of processes such as slurry application, exposure, inversion development, water development, drying and the like are required when forming a color-filter-layer portion and a phosphor-layer portion (refer to Patent Literature 1, 2 and 3). Particularly, when forming a red filter layer, because ferric oxide and cadmium sulfoselenide each used as red pigment have a characteristic of absorbing and not passing ultraviolet rays during the exposure, it is difficult to apply the internal exposure method in which a striped filter layer is formed by performing exposure from the side of the filter-applied film surface. For this reason, what is called a lift-off method has been employed, which has steps of covering a portion other than an area where the intended stripes are to be formed with a resist mask, forming a red filter-applied film including the portion over the resist mask, and then destroying bridges of the resist mask by an inversion agent to obtain the desired striped red filter layer.

On the other hand, in order to overcome such complexity in manufacturing, a method has been proposed in which a transfer sheet made by laminating a color-filter layer and phosphor layer is employed to form the color-filter layer and phosphor layer by the transfer method to greatly reduce the number of processes in the manufacturing (refer to Patent Literature 4). If the color-filter layer is omitted from the transfer sheet, transfer of only the phosphor layer is also possible. Inversely, if the phosphor layer is omitted, only the color-filter layer can also be transferred. In addition, this transfer method can also be applied to formation of an aluminum film serving as the metal-back layer (refer to Patent Literature 5).

Patent Literature 1

Published Japanese Patent Application No. H5-275006

Patent Literature 2

Published Japanese Patent Application No. H9-7530

Patent Literature 3

Published Japanese Patent Application No. 2002-105380

Patent Literature 4

Published Japanese Patent Application No. 2001-43796

Patent Literature 5

Published Japanese Patent Application No. 2001-328229

Conventionally, the color cathode-ray tube having a fluorescent screen with the color-filter layer can reduce the external-light reflectance on the tube surface by means of the color-filter layer and the contrast is improved. Therefore, in the above-described color cathode-ray tube, a panel glass with a high transmissivity, for example, made of what is called clear glass (light transmissivity is 86% when a wavelength is 546 nm and a plate thickness is 10.16 mm) has been employed to improve the luminance. The external-light reflectance on the tube surface of such color cathode-ray tube is at most equivalent to that of a color cathode-ray tube which uses a panel glass with low transmissivity, for example, made of what is called tint glass (light transmissivity is 56.8% when a wavelength is 546 nm and a plate thickness is 10.16 mm) and which also has a fluorescent screen without the color-filter layer.

With this specification, the luminance is improved indeed, however, blackness of the tube surface (what is called tube-surface reflectance) determining a black portion of a picture is not improved, so that the blackness is insufficient to make a feeling of contrast in the picture weakened.

### DISCLOSURE OF THE INVENTION

The present invention provides a display apparatus and a color cathode-ray tube, in which improvement in the luminance or suppression of a decrease in the luminance and also improvement in the contrast in a picture are intended.

A display apparatus according to the present invention has the structure in which a fluorescent screen having a color-filter layer and a phosphor layer is formed on the inside surface of a panel glass having light transmissivity of 55% to 20% when a wavelength is 546 nm and a plate thickness is 20 mm, and at least the phosphor layer is formed by the transfer method.

In the display apparatus according to the present invention, because the phosphor layer is formed by the transfer method, a film thickness of the phosphor layer can be set at a value capable of obtaining the optimum luminance. Further, because a panel glass with low transmissivity is employed, the external-light reflectance can be reduced. Furthermore, a relation between the luminance and the brightness perceived by human beings is nonlinear with the result that while improving the luminance or suppressing a decrease in the luminance, the improvement in contrast can be obtained.

A display apparatus according to the present invention has the structure in which a fluorescent screen having a color filter layer and a phosphor layer is formed on the inside surface of a panel glass, and the phosphor layer is formed by a transfer method using a photosensitive phosphor layer containing no Cr and has a film thickness of 10 μm to 15 μm. It is preferable to use a panel glass with light transmissivity of 55% to 20% when a wavelength is 546 nm and a plate thickness is 20 mm.

In the display apparatus according to the present invention, because the phosphor layer is made of the photosensitive phosphor containing no Cr, the luminance after the baking process is improved as compared with the conventional photosensitive phosphor containing Cr. As a result, the luminance can be improved to improve the contrast as well. When the panel glass is formed of the low-transmissivity glass, the external-light reflectance decreases and further improvement in contrast can be obtained.

A color cathode-ray tube according to the present invention has the structure in which a fluorescent screen having a color-filter layer and a phosphor layer is formed on the inside surface of the panel glass having light transmissivity of 55% to 20% when a wavelength is 546 nm and a plate thickness is 20 mm, and at least the phosphor layer is formed by the transfer method.

In the color cathode-ray tube according to the present invention, because the phosphor layer is formed by the transfer method, the phosphor layer can be made to have a film thickness with which the optimum luminance is obtained. Further, because the panel glass with low transmissivity is employed, the external-light reflectance can be reduced. In addition, a relation between the luminance and the brightness perceived by human beings is nonlinear; as a result, while improving the luminance or suppressing a decrease in the luminance, the improvement in contrast can be obtained.

A color cathode-ray tube according to the present invention has the structure in which a fluorescent screen having a color-filter layer and a phosphor layer is formed on the inside surface of the panel glass, and the phosphor layer is formed by the transfer method using the photosensitive phosphor layer containing no Cr and has a film thickness of 10 μm to 15 μm. It is preferable to use the panel glass having light transmissivity of 55% to 20% when a wavelength is 546 nm and a plate thickness is 20 mm.

In the color cathode-ray tube according to the present invention, because the phosphor layer is made of the photosensitive phosphor containing no Cr, the luminance after the baking process is improved as compared with the conventional photosensitive phosphor containing Cr. Therefore, the luminance can be improved to improve the contrast as well.

When the panel glass is formed of the low-transmissivity glass, the external-light reflectance decreases and further improvement in contrast is obtained.

According to the display apparatus of the present invention, by using the panel glass having light transmissivity of 55% to 20% when a wavelength is 546 nm and a plate thickness is 20 mm, the external-light reflectance can greatly be reduced. In addition, because the apparatus includes the fluorescent screen having the color-filter layer and phosphor layer, and at least the phosphor layer is formed by the transfer method, the luminance can be improved or a decrease in the luminance can be suppressed at the minimum. Therefore, a picture display in high luminance as well as in excellent contrast can be attained.

When either an intermediate film or the metal-back layer on the phosphor layer, or both of them are formed by the transfer method, a planarized reflecting surface can be formed on the inside surface of the metal-back layer, which makes reflection efficiency in the metal-back layer further improved and enables improvement in luminance to be obtained.

When the fluorescent screen is provided in which the metal-back layer is formed directly on the phosphor layer by the transfer method, a planarized reflecting surface can also be formed on the inside surface of the metal-back layer, which makes reflective efficiency in the metal-back layer further improved and enables improvement in luminance to be obtained.

When the phosphor layer in fluorescent screen is formed of the photosensitive phosphor layer containing no Cr, the luminance after the baking process is improved than in related art. Further, when a film thickness of the phosphor layer is set to 10 μm to 15 μm, the optimum luminance can be obtained. Thus, by including the fluorescent screen with the color-filter layer and such phosphor layer, the luminance can be improved. Therefore, it is possible to attain a picture display with excellent contrast as well as high luminance.

In this case, when employing the panel glass having light transmissivity of 55% to 20% when a wavelength is 546 nm and a plate thickness is 20 mm, the external-light reflectance can further be reduced and further improvement in contrast is obtained. If an antireflective film is formed on the other surface, that is, on the outside surface of the panel glass, still further improvement in contrast can be obtained.

According to the color cathode-ray tube of the present invention, by employing the panel glass having light transmissivity of 55% to 20% when a wavelength is 546 nm and a plate thickness is 20 mm, the external-light reflectance can greatly be reduced. In addition, by including the fluorescent screen which has the color-filter layer and phosphor layer and in which at least the phosphor layer is formed by the transfer method, the luminance can be improved, or a decrease in luminance can be suppressed to the minimum. Accordingly, a picture display with excellent contrast in high luminance can be attained.

When either the intermediate film or the metal-back layer on phosphor layer, or both of them are formed by the transfer method, the planarized reflecting surface can be formed on the inside surface of the metal-back layer, which makes the reflective efficiency in the metal-back layer further improved and enables the improvement in luminance to be obtained.

When including the fluorescent screen in which the metal-back layer is directly formed on the phosphor layer by transfer method, the planarized reflective surface can also be formed on the inside surface of the metal-back layer, which makes the reflective efficiency further improved and enables the improvement in luminance to be obtained.

When the phosphor layer of the fluorescent screen is formed of the photosensitive phosphor layer containing no Cr, the luminance after the baking process becomes improved than in related art. Further, if a film thickness of this phosphor layer is set to 10 μm to 15 μm, the optimum luminance can be obtained. Thus, by including the fluorescent screen with the color-filter layer and such phosphor layer, the luminance can be improved. Therefore, it is possible to attain the picture display with excellent contrast in high luminance.

In this case, when employing the panel glass having light transmissivity of 55% to 20% when a wavelength is 546 nm and a plate thickness is 20 mm, the external-light reflectance can further be reduced and further improvement in luminance is obtained. If the antireflective film is formed on the other surface, that is, on the outside surface of the panel glass, still further improvement in contrast can be obtained.

### BRIEF DESCRIPTION OF DRAWINGS

FIG. 1 is a constitutional diagram showing a color cathode-ray tube according to an embodiment of the present invention;

FIG. 2 is a sectional diagram showing the relevant part of the color cathode-ray tube according to an embodiment of the present invention;

FIG. 3 is a sectional diagram showing the relevant part of the color cathode-ray tube according to another embodiment of the present invention;

FIG. 4 is a sectional diagram showing the relevant part of the color cathode-ray tube according to still another embodiment of the present invention;

FIG. 5 is a sectional diagram showing the relevant part of the color cathode-ray tube according to yet another embodiment of the present invention;

FIG. 6 is a characteristic diagram showing a transmissivity characteristic of a panel glass using a tint glass;

FIG. 7 is a characteristic diagram showing a transmissivity characteristic of a color filter;

FIG. 8 is an explanatory diagram with respect to measurement of reflectance at the tube-surface for explaining the present invention;

FIG. 9 is a characteristic diagram showing a relation between the luminance and the brightness perceived by human beings for explaining the present invention;

FIG. 10 is a characteristic diagram showing a relation between a film thickness of a phosphor layer and a relative luminance for explaining the present invention;

FIG. 11 is a sectional diagram showing an example of a transfer sheet applicable to the present invention, in which the phosphor layer and a color-filter layer are laminated;

FIG. 12 is a sectional diagram showing an example of the transfer sheet of the phosphor layer, which is applicable to the present invention;

FIG. 13 is a sectional diagram showing an example of the transfer sheet of the color-filter layer, which is applicable to the present invention;

FIG. 14 is a sectional diagram showing an example of the transfer sheet of an intermediate film, which is applicable to the present invention; and

FIG. 15 is a sectional diagram showing an example of the transfer sheet of a metal-back layer, which is applicable to the present invention.

### BEST MODE FOR CARRYING OUT THE INVENTION

The first characteristic of the present invention is a structure in which a fluorescent screen with a color-filter layer formed by a transfer method is combined with a panel glass having low transmissivity to improve the contrast and the luminance.

The second characteristic of the present invention is a structure in which a film thickness of a phosphor layer in the fluorescent screen with the color filter is optimized and a photosensitive phosphor layer containing no Cr is employed to improve the luminance and the contrast. Further, the surface of a metal-back layer having high planarity and high reflectance (for example, aluminum film) is fabricated by forming at least either an intermediate film or the metal-back layer by the transfer method to improve the luminance.

First, to make the present invention easily understood, a relation between the luminance and the brightness perceived by human beings as well as contrast ratio will be described. The contrast ratio C when applied to, for example, a color cathode-ray tube is conventionally expressed as follows.

Contrast ratio C=the maximum luminance of cathode-ray tube/the luminance when cathode-ray tube is switched off. In this context, the luminance when the cathode-ray tube is switched off corresponds to the luminance of reflected light that is illuminating light (external light) reflected on the tube surface. Thus, assuming that B represents the maximum luminance of the cathode-ray tube, R represents the tube-surface reflectance, and E represents the intensity of illuminating light, the contrast ratio C is expressed as C=B/R×E.

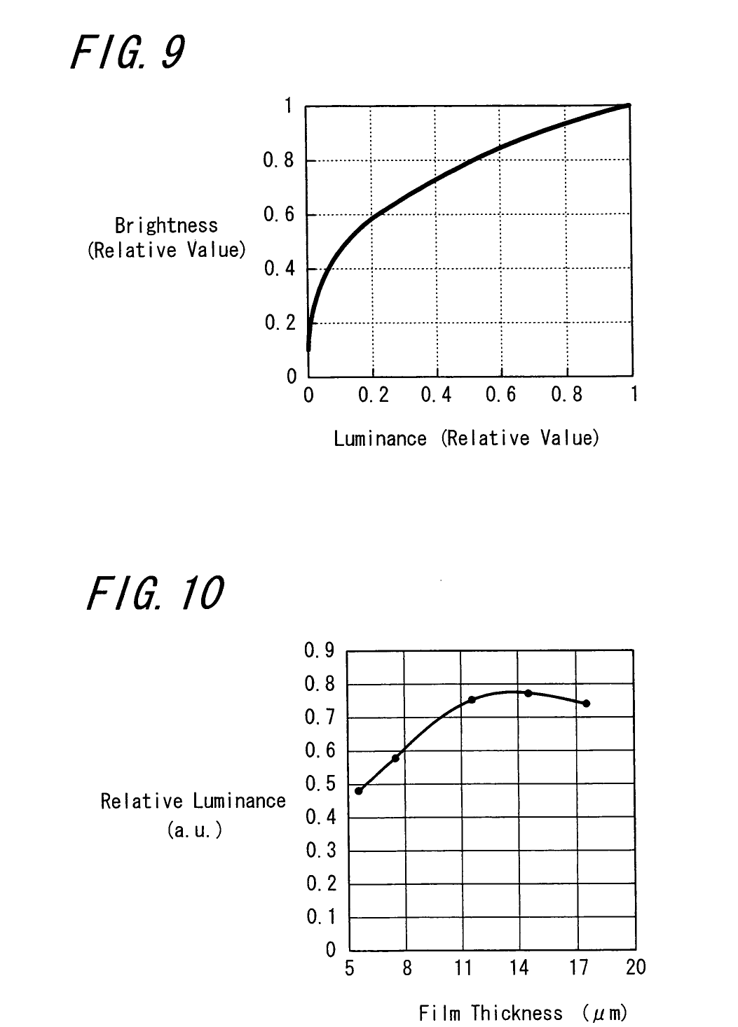

On the other hand, the relation between the luminance and the brightness perceived by human beings is expressed as a graph shown in FIG. 9, which is nonlinear in general. Defining the contrast as a ratio between the maximum brightness and the minimum brightness perceived on the tube surface, it is recognized from the relation shown in FIG. 9 that it is more efficient for improving the contrast to reduce the minimum luminance (when there is no signal, the above-described luminance of reflected light that is external light reflected on the tube surface) rather than to make the luminance improved. That is, to suppress the reflection on the tube surface is advantageous for improving the contrast. Further, due to concurrent comparison effect in which when a luminance level of black becomes low, the luminance of white color existing in the vicinity thereof looks improved, the perceived brightness improves. The present invention makes use of such knowledge.

With the conventional slurry method, if a film thickness of the phosphor layer is increased, then the phosphor stripe is short of adhesive power and will exfoliate from the panel glass. However, in case of the transfer method, by virtue of adhesive power due to heat and adhesive power to the panel glass due to photochemical reaction, the phosphor layer rarely exfoliates even if the film thickness is increased. Thus, it becomes possible to control the film thickness of the phosphor layer so as to correspond with an intruding depth of electron beams injected into the fluorescent screen. FIG. 10 is a graph showing a relation between a film thickness (μm) and relative luminance of the phosphor layer when accelerating voltage is 30 kV. To obtain the optimum luminance, it is preferable for the film thickness to be 1 μm to 15 μm, particularly 13 μm to 14 μm. With the transfer method, since the film thickness is easy to be controlled, the film thickness of the phosphor layer can be set to the above-described thickness (10 μm to 15 μm, particularly 13 μm to 14 μm) at which the luminance is of the optimum value. With the slurry method, from the necessity for making a uniform fluorescent screen, the film thickness of the phosphor layer is obliged to be a thickness thinner than the above-described optimum value (film thickness at which the luminance does not have the optimum value).

In addition, when the phosphor layer is formed by the conventional slurry method, a photosensitive agent containing Cr such as ammonium bichromate is employed. On this account, during the baking process in manufacturing the cathode-ray tube, Cr reacts on phosphor particles and reduces luminance of light-emitting phosphor. Hereupon, when the phosphor layer containing Cr and a phosphor layer containing no Cr are scraped off in baking, and each luminance of their powders are compared, it is recognized that luminance of the phosphor layer containing Cr is lower by 3% to 5% in total. In the present invention, when the phosphor layer is formed by the transfer method, the transfer sheet having a photosensitive phosphor layer including a photosensitive agent containing no Cr is employed. Therefore, when the phosphor layer is formed by the transfer method, the luminance will be improved by 10% to 15% correspondingly to the fact that Cr is not contained and the film thickness is optimized.

Further, it is desired that the intermediate film also be formed by the transfer method before forming the metal-back layer. This makes it possible to form a highly planarized metal-back layer. This improves the luminance by 5% to 10%. Furthermore, forming the antireflective film on the outside surface of the panel glass further makes contrast improved.

FIG. 1 shows an embodiment of the color cathode-ray tube according to the present invention. A color cathode-ray tube 1 according to this embodiment has the structure in which a color fluorescent screen 4 is formed on the inside surface 3a of a panel glass 3 described later on in a cathode-ray tube body (glass tube body) 2, a color selection mechanism such as an aperture grille 5 is arranged opposite to the color fluorescent screen 4, and an electron gun 6 is arranged inside a neck glass 7. A reference numeral 8 denotes a deflection yoke. In this color cathode-ray tube 1, three electron beams B_{R}, B_{G} and B_{B} corresponding to each color of red (R), green (G) and blue (B) emitted from the electron gun 6 are deflected by the deflection yoke 8 in horizontal and vertical directions, penetrate the color selection mechanism 5, and are applied to the fluorescent screen 4 for displaying a required color picture.

In the color cathode-ray tube 1 according to this embodiment, particularly, the panel glass 3 is formed of glass with low transmissivity, that is, glass having light transmissivity of 55% or less and 20% or more (55% to 20%) when a wavelength is 546 nm and a plate thickness is 20 mm, and the phosphor layer or both of the color-filter layer and phosphor layer constituting the fluorescent screen 4 are formed by the transfer method. To make luminance emitted from the fluorescent screen 4 have the optimum value, it is preferable that the phosphor layer or both of the phosphor layer and color-filter layer are formed by the transfer method.

What is generally called tint glass and dark tint glass can be employed as the glass material with light transmissivity of 55% to 20%. Table 1 shows transmissivity of each glass material when the glass thickness t is 10.16 mm and 20 mm, and a light wavelength is 546 nm.

TABLE 1

Wavelength 546 nm

| | t = 10.16 mm | t = 20 mm |
|---|---|---|
| Clear glass | 86% | 81% |
| Low clear glass | 80% | 70% |
| Tint glass | 56.8% | 36% |
| Dark tint glass | 42% | 20% |

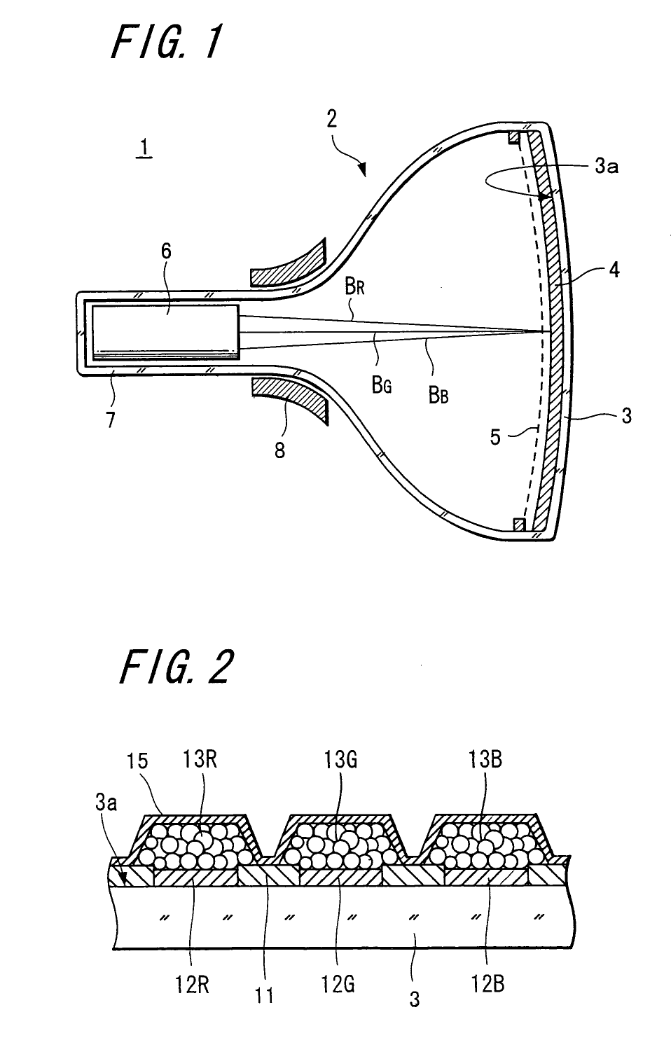

FIG. 2 shows an embodiment of the relevant part of the panel glass 3 and fluorescent screen 4 in the-above color cathode-ray tube 1. In this embodiment, the panel glass 3 is formed of glass having a transmissivity characteristic as shown in FIG. 6 (for example, tint glass made by Nihon Denki Glass Co. Ltd.: plate thickness t=20 mm), and the color fluorescent screen 4 including each phosphor layer 13 [13R, 13G, 13B] of red, green and blue color and a color-filter layer 12 [12R, 12G, 12B] of red, green and blue color, the same colors as those of the phosphor layer 13, is formed on the inside surface 3a of the panel glass 3 by the transfer method.

The fluorescent screen 4 is formed as follows; a light-absorbing layer that is, for example, a carbon layer 11, a two-layered film of a red filter layer 12R and a red phosphor layer 13R, a two-layered film of a green filter layer 12G and a green phosphor layer 13G, and a two-layered film of a blue filter layer 12B and a blue phosphor layer 13B between pieces of the carbon-layer 11 are formed on the inside surface 3a of the panel glass 3; and over the phosphor layer 13 [13R, 13G, 13B] is formed a metal-back layer, for example, an aluminum reflective film 15 through an intermediate film (not shown). In this embodiment, the carbon layer 11 and phosphor layer 13 of each color are formed as striped layers.

For each color phosphor, P-22 phosphor under Japanese Industrial Standards can be employed, which is quite the same as in the conventional color cathode-ray tube. Examples of pigment dispersed in the color-filter layer 12, namely, inorganic metallic oxide will be cited next. As pigment in the red-filter layer 12R, Fe₂O₃ is used. As pigment in the green-filter layer 12G, TiO₂.NiO.ZnO is used. As pigment in the blue-filter layer 12B, CoO.Al₂O₃ is used.

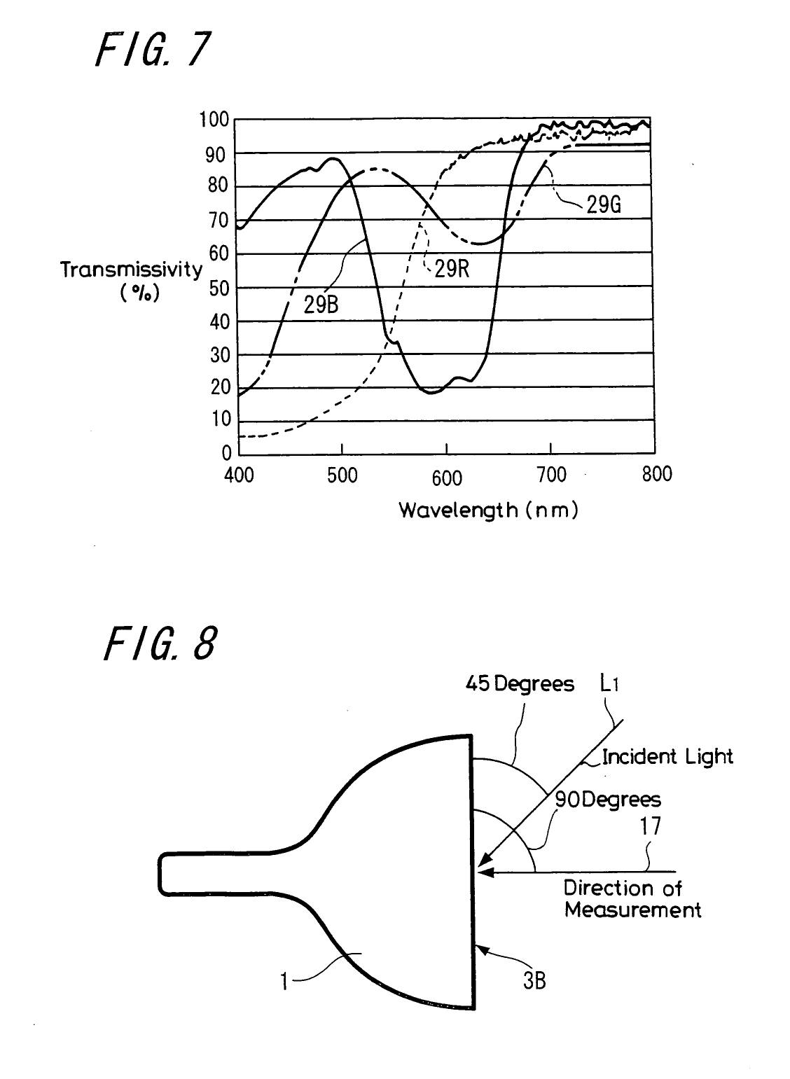

In this embodiment, each color-filter layer in red, green, blue color of 12R, 12G, 12B having characteristics as shown in FIG. 7 is formed by the transfer method; and each color phosphor layer 13R, 13G, 13B and the intermediate film are also formed by the transfer method. In FIG. 7, 29R denotes a characteristic of the red filter; 29G denotes that of the green filter; 29B denotes that of the blue filter.

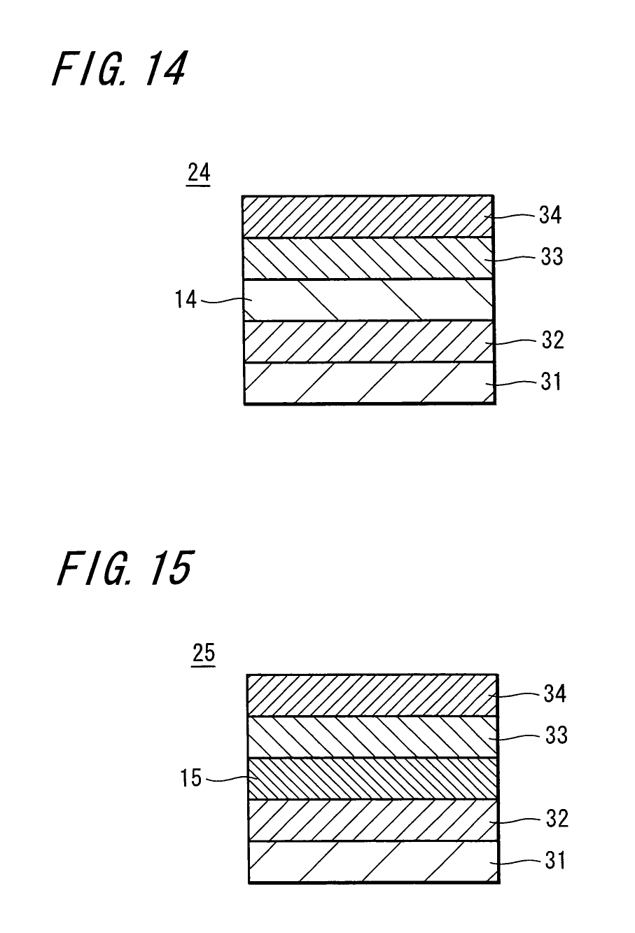

FIG. 12 shows an example of the transfer sheet employed when the phosphor layer 13 is formed by the transfer method. FIG. 14 shows an example of the transfer sheet employed when the intermediate film is formed by the transfer method. The transfer sheet 22 of the phosphor layer is formed as follows; on a base film 31 forming a support are sequentially formed a cushion layer 32 made of, for example, thermoplastic resin, a photosensitive phosphor layer 13, and a photosensitive adhesive layer 33; on the top surface is formed a cover film 34 for protecting the photosensitive adhesive layer 33. Note that here a photosensitive agent containing no Cr is employed in the photosensitive phosphor layer 13. The transfer sheet 22 is prepared for each color. The transfer sheet 24 for the intermediate film is formed as follows; on the base film 31 forming the support are sequentially formed the cushion layer 32 made of, for example, thermoplastic resin, the intermediate film 14, and the photosensitive adhesive layer 33, and on the top surface is formed the cover film 34 for protecting the photosensitive adhesive layer 33.

The transfer sheets 22 and 24 are used as follows. First, after the cover film 34 of the transfer sheet 22 for a first color phosphor layer is exfoliated, the transfer sheet 22 is disposed such that the photosensitive adhesive layer 33 is adhered to the panel glass 3 on which the carbon layer 11 and each color-filter layer 12 [12R, 12G, 12B] are formed in advance, and is heated and pressed with a transfer roller from the side of the base film 31 to perform transfer, and then, the base film 31 and cushion layer 32 are exfoliated. This makes the first color phosphor layer 13 adhered through the photosensitive adhesive layer 33. Next, the exposure is made from the inside 3a of the panel glass 3 through the color selection mechanism 5 and the development is made to form the first color phosphor layer 13 in a predetermined pattern, in this embodiment a striped pattern. The same process is repeated to form the phosphor layer 13 of a second color and a third color. Next, after the cover film 34 of the transfer sheet 24 for the intermediate film is exfoliated, the transfer sheet 24 is disposed similarly to cover the phosphor layer 13 and carbon layer 11, is heated and pressed with the transfer roller from the side of the base film 31 to perform transfer, and then the base film 31 and cushion layer 32 are exfoliated. This makes the intermediate film 14 having a planarized surface adhered. Subsequently, the metal-back layer, for example, the aluminum reflective film 15 is formed on the intermediate film and the baking process is made to form the color fluorescent screen 4 intended.

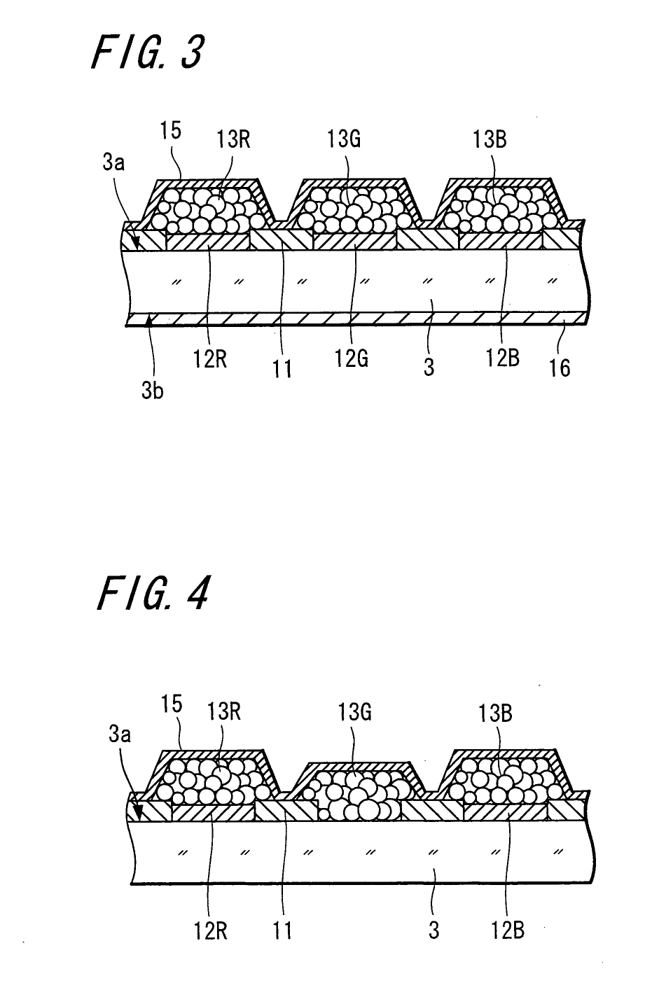

FIG. 3 shows another embodiment of the relevant part of the panel glass 3 and fluorescent screen 4 in the above-described color cathode-ray tube 1. This embodiment has the panel glass 3 and fluorescent screen 4 of the same structure as in FIG. 2 and further includes an antireflective film 16 optically stuck to the front surface 3b of the panel glass 3. The antireflective film 16 in this embodiment is made to have mirror reflectance of 0.5% and transmissivity of 95%.

Results of measurement of the tube-surface reflectance and luminance of the color cathode-ray tube 1 according to the embodiments having the structure of FIG. 2 and FIG. 3 are shown in Table 2 as compared with the conventional color cathode-ray tube. In Table 2, the tube-surface reflectance was measured, as shown in FIG. 8, in the direction perpendicular to the tube surface 3B of the color cathode-ray tube 1, while making incident light L₁ enter at an angle of 45° with respect to a vertical direction. A reference numeral 17 denotes the direction of measurement. White luminance represents the luminance at color temperature 10000K.

A conventional tube has the panel glass formed of tint glass, no color filter provided on the fluorescent screen, and the phosphor layer and intermediate film formed by the slurry method. The comparison was made by relative values to those of the conventional tube defined as 100%.

TABLE 2

| | Relative | |
|---|---|---|
| | tube-surface | Relative white |
| | reflectance | luminance (10000 K) |
| Conventional tube | 100% | 100% |
| (without filter) | | |
| Antireflective film, low- | 40% | 90% |
| transmissivity panel glass, | | |
| red, green, blue | | |
| color filters | | |
| Low-transmissivity panel | 39% | 93% |
| glass, red, green, blue | | |
| color filters | | |

As is seen from Table 2, because each of the color cathode-ray tubes 1 according to the embodiments of FIGS. 2 and 3 that has the fluorescent screen 4 with color filters includes the phosphor layer 13 and intermediate film 14 formed by the transfer method, a film thickness of the phosphor layer 13 is optimized and the reflective surface (inside surface) of the aluminum reflective film 15 forming the metal-back layer is planarized. As a result, the optimized luminance of 90% or 93% can be obtained without causing a large decrease in luminance as compared with the conventional tube. Further, because RGB color filters are applied, it is recognized that the tube-surface reflectance greatly decreases to 40% or 39% as compared with the conventional tube. Therefore, in the color cathode-ray tube according to each of the embodiments, improvement in contrast can be obtained while suppressing a decrease in luminance to the minimum.

It is also verified that characteristics of the color cathode-ray tube whose color-filter layer 12, phosphor layer 13, and intermediate film 14 are formed by the transfer method are equivalent to those of Table 2.

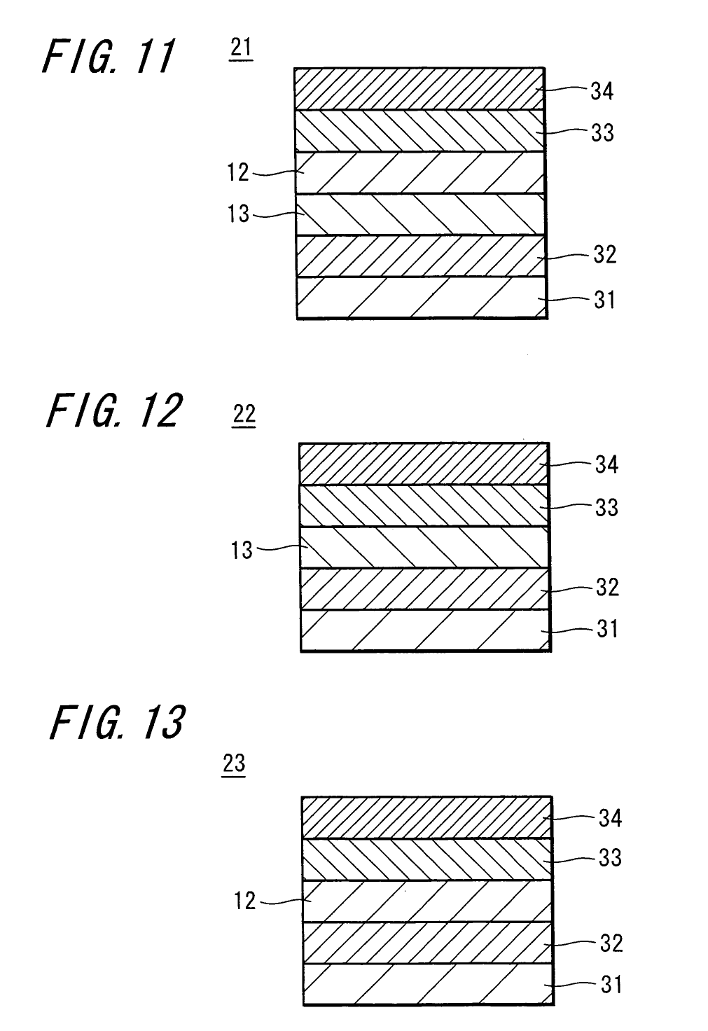

In addition, an example of the transfer sheet employed when the color filter 12 and phosphor layer 13 are formed by the transfer method is shown in FIG. 11. The transfer sheet 21 in this example is formed as follows; on the base film 31 as a support are sequentially formed the cushion layer 32 made of, for example, thermoplastic resin, the photosensitive phosphor layer 13, a color-filter layer 12 of the same color as that of the phosphor layer, and the photosensitive adhesive layer 33, on the top surface of which the cover film 34 for protecting the photosensitive adhesive layer 33 is formed. This transfer sheet 21 is prepared for each color and used as follows. The transfer sheet 21 for a first color is disposed after the cover film 34 is exfoliated, such that the photosensitive adhesive layer 33 is adhered to the panel glass 3 side on which the carbon layer 11 is formed in advance, is heated and pressed with the transfer roller from the side of the base film 31 to perform transfer, and then the base film 31 and cushion layer 32 are exfoliated. In this way, the two-layered film of the photosensitive phosphor layer 13 and color-filter layer 12 is adhered through the photosensitive adhesive layer 33. Next, the exposure is made from the inside of the panel glass 3 through the color selection mechanism 5 and the development is made to form the first color phosphor layer 13 and color-filter layer 12. The same processes are repeated to form the second color and the third color phosphor layer 13 and color-filter layer 12. Subsequently, the intermediate film and the metal-back layer, for example, aluminum reflective film 15 are formed.

FIG. 4 shows still another embodiment of the relevant part of the panel glass 3 and fluorescent screen 4 in the color cathode-ray tube 1. In this embodiment, the panel glass 3 is made of tint glass similarly to the embodiment in FIG. 2, only color-filter layers of the red filter layer 12R and the blue filter layer 12B are formed by the slurry method, and the fluorescent screen 4 having phosphor layer 13 [13R, 13G, 13B] formed by the transfer method.

Further in this embodiment, the color cathode-ray tube having the same structure as in FIG. 4 in which the antireflective film 16 is stuck on the surface of panel glass 3 as in FIG. 3 is constructed.

The tube-surface reflectance and luminance of the color cathode-ray tubes 1 of the embodiments having the structure in FIG. 4 and having the structure in which the antireflective film is further stuck were measured; and results of the measurement compared with the conventional color cathode-ray tube are shown in Table 3. This table is an evaluation under the same conditions as in the above Table 2.

TABLE 3

| | Relative | |
|---|---|---|
| | tube-surface | Relative white |
| | reflectance | luminance (10000 K) |
| Conventional tube | 100% | 100% |
| (without filter) | | |
| Antireflective film, low- | 50% | 95% |
| transmissivity panel glass, | | |
| red and blue color filter | | |
| Low-transmissivity panel | 49% | 98% |
| glass, red and blue | | |
| color filter | | |

As is seen from Table 3, in the color cathode-ray tube 1 having the fluorescent screen 4 with the color filter in FIG. 4 according to this embodiment, the luminance can be optimized similarly to FIGS. 2 and 3, thus enabling luminance of 95% or 98% to be obtained without causing a large decrease in luminance as compared with the conventional tube. It is also recognized that the tube-surface reflectance is greatly reduced to 50% or 49% as compared with the conventional tube. Therefore, the color cathode-ray tube according to this embodiment enables the contrast to be improved while suppressing a decrease in the luminance to the minimum.

Further, it is verified that characteristics of a color cathode-ray tube in which the color-filter layer 12, phosphor layer 13 and intermediate film 14 are formed by the transfer method in addition to the same structure as in FIG. 4 are equivalent to those in Table 3.

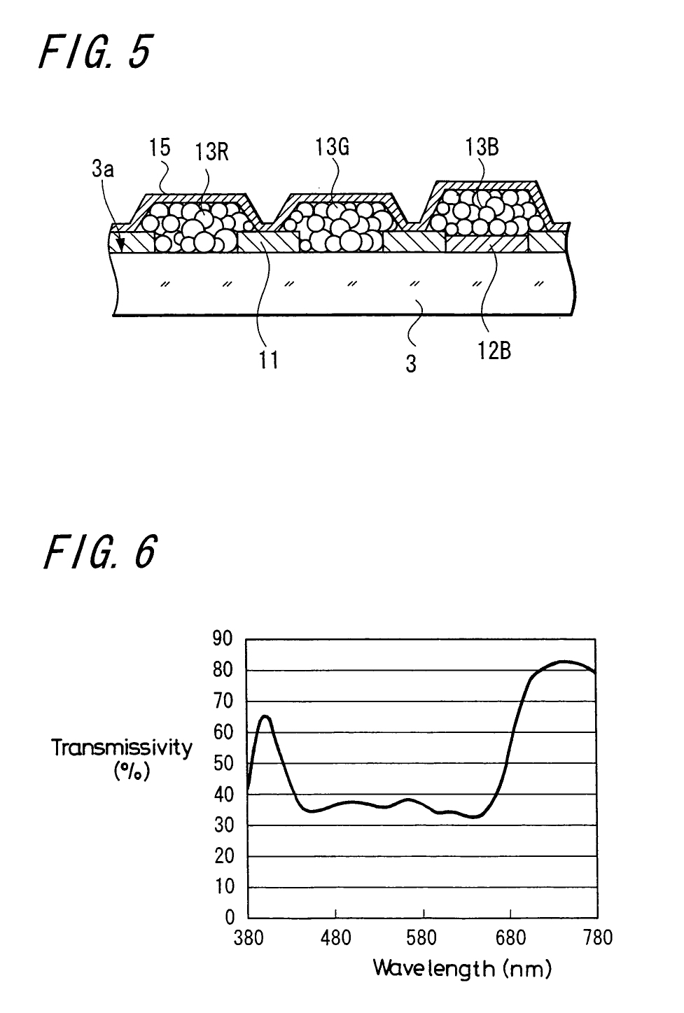

FIG. 5 shows yet another embodiment of the relevant part of the panel glass 3 and fluorescent screen 4 in the color cathode-ray tube 1. In this embodiment, the panel glass 3 is made of tint glass similarly to FIG. 2, and the fluorescent screen 4 includes only the color-filter layer of the blue color filter layer 12B formed by the slurry method and the phosphor layer 13 [13R, 13G, 13B] formed by the transfer method.

Further in this embodiment, the color cathode-ray tube having the same structure as in FIG. 5 in which the antireflective film 16 similar to that of FIG. 3 is further stuck on the surface of the panel glass 3 is constructed.

The tube-surface reflectance and luminance of the color cathode-ray tubes 1 of the embodiments having the structure in FIG. 5 and having the structure in which the antireflective film is further stuck were measured; and results of the measurement are shown in Table 4 compared with the conventional color cathode-ray tube. This table is an evaluation under the same conditions as the above Table 2.

TABLE 4

| | Relative | |
|---|---|---|
| | tube-surface | Relative white |
| | reflectance | luminance (10000 K) |
| Conventional tube | 100% | 100% |
| (without filter) | | |
| Antireflective film, low- | 70% | 110% |
| transmissivity panel glass, | | |
| blue color filter | | |
| Low-transmissivity panel | 69% | 113% |
| glass, blue color filter | | |

As is seen from Table 4, the color cathode-ray tube 1 having the fluorescent screen 4 with a color filter in FIG. 5 according to this embodiment enables the luminance to be optimized similarly to FIGS. 2 and 3, and larger luminance of 110% or 113% than that of the conventional tube to be obtained. Further, it is also recognized that the tube-surface reflectance is greatly reduced to 70% or 69% as compared with the conventional tube. Therefore, the color cathode-ray tube according to this embodiment can improve the contrast along with improving the luminance.

Further, it is verified that characteristics of the color cathode-ray tube in which the color-filter layer 12, phosphor layer 13 and intermediate film 14 are formed by the transfer method in the same structure as in FIG. 5 are equivalent to those in Table 4.

In the above-described embodiments, the phosphor layer is formed by the transfer method, whereas the color-filter layer can also be formed by the transfer method. An example of the transfer sheet of this case is shown in FIG. 13. The transfer sheet 23 for the color-filter layer is formed as follows; on the base film 31 as a support are sequentially formed the cushion layer 32 made of, for example, a thermoplastic resin, the color-filter layer 12, and the photosensitive adhesive layer 33, on the top surface of which the cover film 34 for protecting the photosensitive adhesive layer 33 is formed.

In the above-described embodiments, the metal-back layer, for example, aluminum reflective film 15 is formed by vapor deposition, it can also be formed by the transfer method. An example of the transfer sheet for this case is shown in FIG. 15. The transfer sheet 25 for the metal-back layer is formed as follows; on the base film 31 as a support are sequentially formed the cushion layer 32 made of, for example, a thermoplastic resin, the metal-back layer, for example, aluminum film 15, and the photosensitive adhesive layer 33, on the top surface of which the cover film 34 for protecting the photosensitive adhesive layer 33 is formed.

As described above, according to the color cathode-ray tube 1 of those embodiments, the conventionally observed contradiction between the luminance and blackness of tube surface, what is called low tube-surface reflectance can be solved by the low-transmissivity panel glass, the color filter technique and the transfer method, and therefore with suppressing the decrease in luminance or with improving the luminance, a picture with excellent contrast can be obtained.

Particularly, when forming the phosphor layer by the transfer method, the film thickness can be controlled to obtain the optimum luminance and the luminance can be improved. Further, because the photosensitive agent containing no Cr is used in the phosphor layer of the transfer sheet, the improvement of luminance can be obtained accordingly. Furthermore, since at least either the intermediate layer or the metal-back layer is formed using a transfer method and also the surface of Al-film is further planarized as the metal-back layer, still further improvement of luminance can be obtained. With the combination of the formation of phosphor layers by a transfer method and a low-transmissivity panel glass, the color cathode-ray tube having compatibility between the luminance and contrast can be provided.

When the color-filter layer and the phosphor layer are concurrently formed by a transfer method, the number of steps in manufacturing can be reduced as compared with related art employing a slurry method.

Moreover, another embodiment of the color cathode-ray tube according to the present invention has the structure in which the fluorescent screen 4 having the color-filter layer 12 [12R, 12G, 12B] and phosphor layer 13 [13R, 13G, 13B] is formed on the inside surface of the panel glass 3, the phosphor layer 13 is formed by the transfer method using the above-described transfer sheet 21 or 22 including the photosensitive phosphor layer 13 containing no Cr, and a film thickness of the phosphor layer 13 is made to be 10 μm to 15 μm. It is preferable to employ the panel glass 3 having light transmissivity of 55% to 20% when a wavelength is 546 nm and a plate thickness is 20 mm.

According to the color cathode-ray tube of this embodiment, since the phosphor layer 13 is formed using the transfer sheet 21 or 22 including the photosensitive phosphor layer 13 containing no Cr, the luminance after the baking process is improved as compared with the case by a slurry method. Concurrently, because the film thickness of the phosphor layer can be set to 10 μm to 15 μm, the optimum luminance can be obtained. Therefore, the luminance can be improved with contrast in picture to be also improved. Furthermore, by employing the panel glass 3 having light transmissivity of 55% to 20% when a wavelength is 546 nm and a plate thickness is 20 mm, the contrast in picture can further be improved.

The color cathode-ray tube 1 according to the embodiments may be incorporated into other set such as a television set and a display monitor to be implemented as a display apparatus.

According to such display apparatus, a display picture having an excellent contrast can be obtained while improving the luminance or suppressing the deterioration of luminance to the minimum.

Having described above the example in which the present invention is applied to the color cathode-ray tube and the display apparatus including the tube, the present invention can also be applied to the other display apparatus such as a plasma display (PDP) and a field-emission display (FED).

### DESCRIPTION OF REFERENCE NUMERALS

1 COLOR CATHODE-RAY TUBE
2 CATHODE-RAY TUBE BODY
3 PANEL GLASS
4 COLOR FLUORESCENT SCREEN
5 COLOR SELECTION MECHANISM
6 ELECTRON GUN
7 NECK GLASS
8 DEFLECTION YOKE
11 CARBON LAYER
12 [12R, 12G, 12B] . COLOR-FILTER LAYER
13 [13R, 13G, 13B] . PHOSPHOR LAYER
14 INTERMEDIATE FILM
15 METAL-BACK LAYER
16 ANTIREFLECTIVE FILM
22, 23, 24, 25 TRANSFER SHEET
31 BASE FILM
32 CUSHION LAYER
33 PHOTOSENSITIVE ADHESIVE LAYER
34 COVER FILM
29R RED FILTER CHARACTERISTIC
29G GREEN FILTER CHARACTERISTIC
29B BLUE FILTER CHARACTERISTIC
17 DIRECTION OF MEASUREMENT

1. A display apparatus comprising: a fluorescent screen including a color-filter layer and a phosphor layer, which is formed on the inside surface of a panel glass having light transmissivity of 55% to 20% when a wavelength is 546 nm and a plate thickness is 20 mm and in which at least said phosphor layer is formed by a transfer method.

2. A display apparatus according to claim 1, wherein the fluorescent screen is provided in which either an intermediate film or a metal-back layer on the phosphor layer, or both the intermediate film and the metal-back layer are formed by the transfer method.

3. A display apparatus according to claim 1, wherein the fluorescent screen on which the metal-back layer is directly formed by the transfer method is provided.

4. A display apparatus comprising: a fluorescent screen including a color-filter layer and a phosphor layer, which is formed on the inside surface of a panel glass and in which said phosphor layer is formed by a transfer method using a photosensitive phosphor layer containing no Cr and a film thickness of the phosphor layer is 10 μm to 15 μm.

5. A display apparatus according to claim 4, wherein as said panel glass, a panel glass having light transmissivity of 55% to 20% when a wavelength is 546 nm and a plate thickness is 20 mm is employed.

6. A display apparatus according to claim 1, wherein an antireflective film is formed on the outside surface of said panel glass.

7. A display apparatus according to claim 2, wherein an antireflective film is formed on the outside surface of said panel glass.

8. A display apparatus according to claim 3, wherein an antireflective film is formed on the outside surface of said panel glass.

9. A display apparatus according to claim 4, wherein an antireflective film is formed on the outside surface of said panel glass.

10. A display apparatus according to claim 5, wherein an antireflective film is formed on the outside surface of said panel glass.

11. A color cathode-ray tube comprising: a fluorescent screen including a color-filter layer and a phosphor layer, which is formed on the inside surface of a panel glass having light transmissivity of 55% to 20% when a wavelength is 546 nm and a plate thickness is 20 mm and in which at least said phosphor layer is formed by a transfer method.

12. A color cathode-ray tube according to claim 11, wherein the fluorescent screen is provided in which either an intermediate film or a metal-back layer on the phosphor layer, or both the intermediate film and the metal-back layer are formed by the transfer method.

13. A color cathode-ray tube according to claim 11, wherein the fluorescent screen on which the metal-back layer is directly formed by the transfer method is provided.

14. A color cathode-ray tube comprising: a fluorescent screen including a color-filter layer and a phosphor layer, which is formed on the inside surface of a panel glass and in which said phosphor layer is formed by a transfer method using a photosensitive phosphor layer containing no Cr and a film thickness of the phosphor layer is 10 μm to 15 μm.

15. A color cathode-ray tube according to claim 14, wherein as said panel glass, the panel glass having light transmissivity of 55% to 20% when a wavelength is 546 nm and a plate thickness is 20 mm is employed.

16. A color cathode-ray tube according to claim 11, wherein an antireflective film is formed on the outside surface of said panel glass.

17. A color cathode-ray tube according to claim 12, wherein an antireflective film is formed on the outside surface of said panel glass.

18. A color cathode-ray tube according to claim 13, wherein an antireflective film is formed on the outside surface of said panel glass.

19. A color cathode-ray tube according to claim 14, wherein an antireflective film is formed on the outside surface of said panel glass.

20. A color cathode-ray tube according to claim 15, wherein an antireflective film is formed on the outside surface of said panel glass.
